(19) United States
(12) Patent Application Publication
(10) Pub. No.: US 2007/0259305 A1
(43) Pub. Date: Nov. 8, 2007

(54) ORTHODONTIC LIGATURE

(76) Inventor: Eric Thomas Eldon Roberts, North Wales (GB)

Correspondence Address: Michael A. O'Neil;Michael A. O'Neil, P.C., Suite 820, 5949 Sherry Lane, Dallas, TX, 75225, US

(21) Appl. No.: 11/742,916

(22) Filed: May 1, 2007

Related U.S. Application Data
(60) Provisional application No. 60/746,204, filed on May 2, 2006.

(51) Int. Cl. A61C 3/00

(52) U.S. Cl. 433/11

(57) ABSTRACT

An orthodontic ligature to be applied in fixed appliance orthodontic treatments, such as dental braces (also known as orthodontic braces), that eliminates friction at an archwire/bracket interface by forming a channel between a bracket and a ligature, an archwire being displaced in the channel, so as to facilitate tooth movement.

### CROSS-REFERENCE TO RELATED APPLICATION

Applicant claims priority based on provisional patent application Ser. No. 60/746,204 filed May 2, 2006, the entire content of which is incorporated herein by reference.

### TECHNICAL FIELD

This invention relates to orthodontics, and more particularly to an orthodontic ligature to be applied in fixed appliance orthodontic treatments that eliminates friction at an archwire/bracket interface so as to facilitate tooth movement.

### BACKGROUND AND SUMMARY

The present invention comprises an orthodontic ligature to be applied in fixed appliance orthodontic treatments, such as dental braces (also known as orthodontic braces), that eliminates friction at an archwire/bracket interface so as to facilitate tooth movement.

Braces are well known and commonly used in orthodontics to correct alignment of teeth and their positioning. For instance, braces are used to correct malocclusions such as under-bites, over-bites, cross-bites, open-bites, crooked teeth, and various other dental conditions for both cosmetic and dental health related reasons. Braces are also often used in conjunction with other orthodontic appliances to widen the palate or jaws, create or eliminate spaces between teeth, or to otherwise move and shape teeth.

Generally, teeth move through the application of mild force at timed intervals. Braces are one mechanism of accomplishing this. One form of braces comprises brackets which are affixed to the teeth, means of affixing the brackets to the teeth, in some instances dental bands, an archwire or archwires, and a means of binding the archwire (s) to the respective brackets. Braces, particularly brackets, can be constructed of metallic, ceramic, or transparent materials.

Brackets are first bonded to the teeth. Archwires are then inserted into archwire slots of the brackets. Ligatures, generally small pieces of elastic, are used to affix the archwire to the brackets. Ligatures are usually changed at each adjustment and come in a variety of shapes and colors. A force applied by the archwire pushes the teeth in a desired direction, also triggering a biological response, so as to achieve the prescribed effect.

As part of the treatment, elastics are often used to close open-bites, shift various alignments, and to create stronger forces necessary to move some teeth or the jaws. Brackets which hooks can be utilized, or hooks can be created and affixed to the archwire, so as to provide a means by which to fix the elastic. Extractions and expansions of teeth are often commonly utilized in conjunction with braces so as to make room for teeth that need to be moved.

A tooth will usually move about one millimeter per month during the course of orthodontic treatment, but there is high individual variability, and thus a wide range of response to orthodontic treatment. Typical treatment time ranges from six months to six years. One of the obstacles that must be overcome to achieve tooth movement is friction at the archwire/bracket interface. When a conventional circular tie elastomeric ligature is used to hold an archwire in the archwire slots of the respective brackets, the ligature binds directly onto the archwire thereby increasing the frictional force necessary to move teeth. Eliminating this friction will result in faster results and facilitate better treatment.

In an attempt to overcome the forgoing problems associated with conventional ligatures, self-ligating brackets have been utilized so as to eliminate the necessity of using elastomeric ligature ties to bind the archwire to the archwire slots of the respective brackets. These brackets are commonly constructed with a slide or clip means which can be moved to allow exposure of the archwire slot for the insertion of the archwire. The slide or clip means is then moved over the archwire so as to convert the archwire slot to a channel. Such self-ligating brackets are undesirable because they incorporate additional bracket parts, adding to the discomfort and diminished aesthetic appeal associated with braces. Further, because of the high cost associated with such prior art self-ligating brackets, they are not a viable option in most cases.

Therefore, a solution to the forgoing problem characterized by the prior art is needed. The present invention addresses and overcomes this problem. In accordance with the broader aspects of the invention, the archwire slots of the respective brackets are converted into a channel so as to considerably reduce the frictional force at the archwire/bracket interface. This is accomplished because direct binding contact between the archwire and the bracket is eliminated. Therefore, smaller forces are necessary to achieve tooth movement which speeds up the time necessary to achieve the desired results and results in less pain and discomfort for the patient.

In accordance with the present invention the archwire slots of the respective brackets are converted into a channel using a modified elastomeric ligature. The use of the ligature of the present invention allows an orthodontist to employ conventional techniques while utilizing well known brackets, such as common metal or ceramic brackets. Upon application of the ligature of the present invention the “conversion cap” of the ligature, which converts a traditional archwire slot into a channel, overlies the archwire slots of the respective brackets and the retention components of the ligature do not contact or bind the archwire.

In overcoming the forgoing problem(s) associated with the prior art the present invention provides at least the following advantages 1) Friction is reduced at the archwire/bracket interface; 2) the design, of the ligature ensures a) the archwire slot is converted into a channel by the conversion cap and b) the ligature does not contact the archwire mesiodistally; 3) the design prevents mesial/distal and occlusal/gingival movement during treatment; 4) the conversion cap stays in place over the archwire slot; 5) universal application for twin brackets reduces necessary inventory; 6) retention of the ligature on the bracket is excellent; 7) the ligature is easily applied using a clockwise method of positioning onto the four tie wings of a bracket by utilizing conventional forceps; 8) the cost of utilizing the ligature is considerably reduced as compared to the utilization of self-ligating brackets; 9) the application technique does not require any specialized instruments; and 10) during treatment the ligature will perform satisfactorily for at least in excess of twelve (12) weeks. The unique design of the ligature further has the following advantages: 11) The round retention holes of the ligature result in fewer stress points when the ligature is positioned on the bracket, and therefore reduce the likelihood of tearing; 12) the peripheral retention components of the ligature do not encroach on the archwire; 13) the central retention components of the ligature ensure that the conversion cap remains accurately positioned over the archwire slot throughout treatment; and 14) the ligature can be used with conventional metal and ceramic brackets.

### BRIEF DESCRIPTION OF THE DRAWINGS

A more complete understanding of the present invention may be had by reference to the following Detailed Description when taken in connection with the accompanying Drawings, wherein:

FIG. 1 is a perspective view of a prior art bracket, archwire, and ligature application;

FIG. 2 is a perspective view of a conventional ceramic bracket commonly utilized in orthodontic applications;

FIG. 3 is a perspective view of a conventional metal bracket Commonly utilized in orthodontic applications;

FIG. 4 is a perspective view of a ligature of the present invention; and

FIGS. 5A though 5I, respectively, show the steps necessary to apply the ligature of the present invention.

### DETAILED DESCRIPTION

Referring now to the drawings, and particularly to FIG. 1 thereof, a conventional bracket 2, archwire 4, and ligature 6 application are shown. As discussed heretofore FIG. 1 shows that in accordance with the application of conventional ligatures the archwire 4 is bound to the bracket 2 by the ligature 6 so that the archwire 4 is in direct contact with the bracket 2 and the ligature 6 creating an undesirable frictional force at the archwire/bracket interface 7.

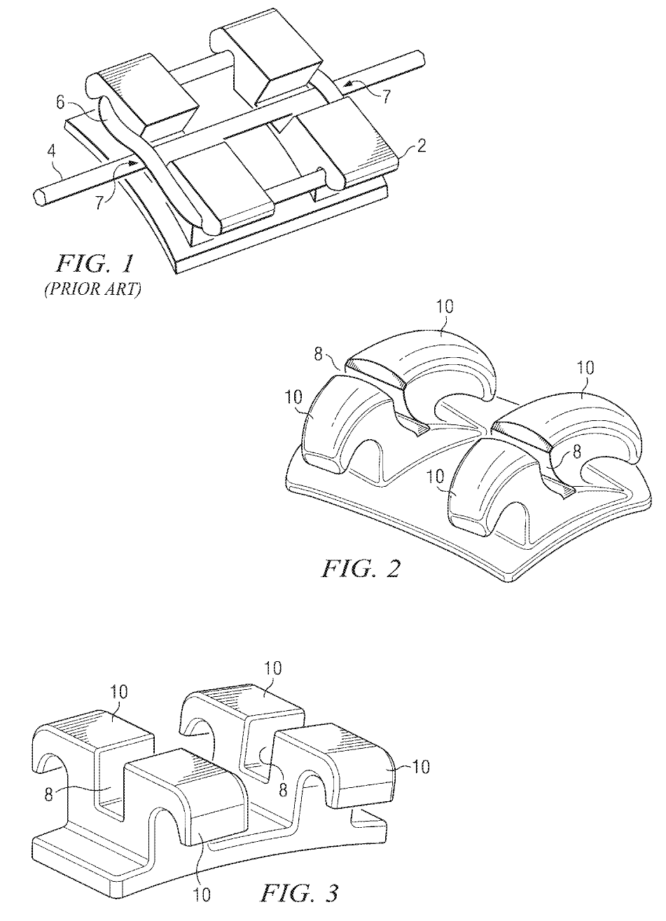

Referring now to FIGS. 2 and 3 of the drawings a conventional ceramic bracket and a conventional metal bracket are shown respectively. A conventional bracket is affixed to a tooth using conventional means of affixation well known to those skilled in the art. Conventional brackets are disposed with an archwire slot 8 in the center thereof and incorporate four (4) tie wings 10 for holding a ligature in place over an archwire. As discussed heretofore one of the advantages of the ligature of the present invention is that it can be used with both conventional metal and ceramic brackets.

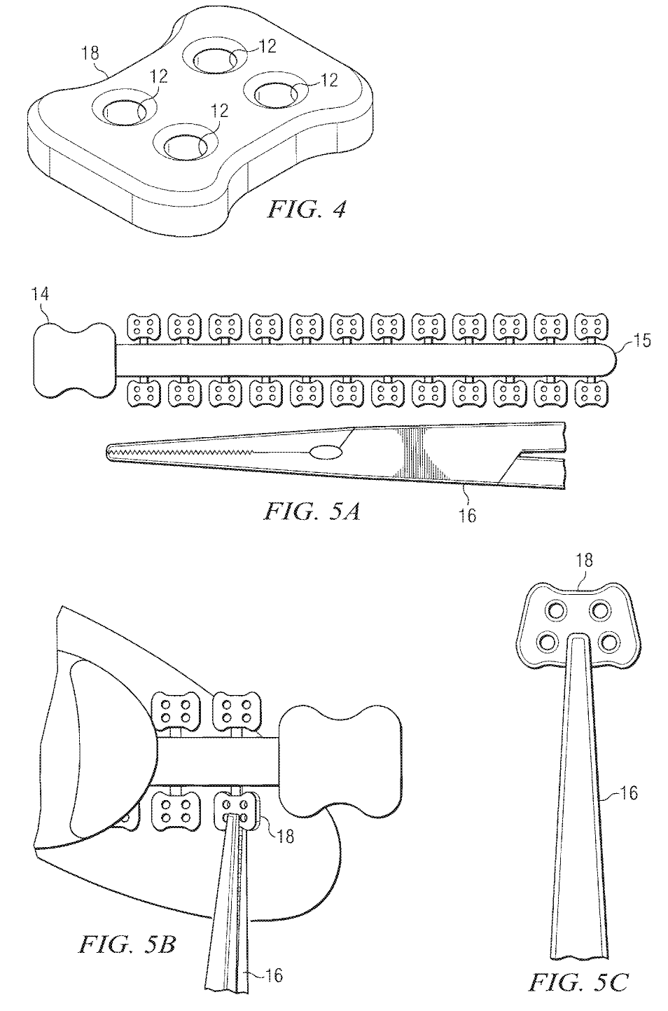

Referring now to FIG. 4 a ligature of the present invention is shown. The ligature can be made from common elastomeric materials well known to those skilled in the art such as those used to make conventional ligatures as well as polyurethane, etc., and can be of any desired color. The ligature is dimensioned so as to fit over conventional brackets. The ligature is rectangular in shape with slight grooves or indentations at the sides. Four holes or apertures 12 are disposed in the ligature, the position of the apertures 12 matching the position of the tie wings of a bracket. Between and around the apertures 12 the ligature is solid in construction so as to form a conversion cap when the ligature is applied to a bracket, thus converting an archwire slot into a channel and eliminating friction at the archwire/bracket interface. This is because the ligature does not contact the archwire mesiodistally.

In one embodiment the ligature is 0.145 inches long, 0.125 inches wide at the ends, 0.095 inches wide at the sides, and 0.028 inches thick, with an inside aperture diameter of 0.02 inches, a distance between apertures of 0.04 inches at the side of the ligature measuring 0.125 inches, the occlusal-gingival side, and 0.06 inches at the side measuring 0.145 inches, the mesial-distal side, measured from the centers of the apertures respectively.

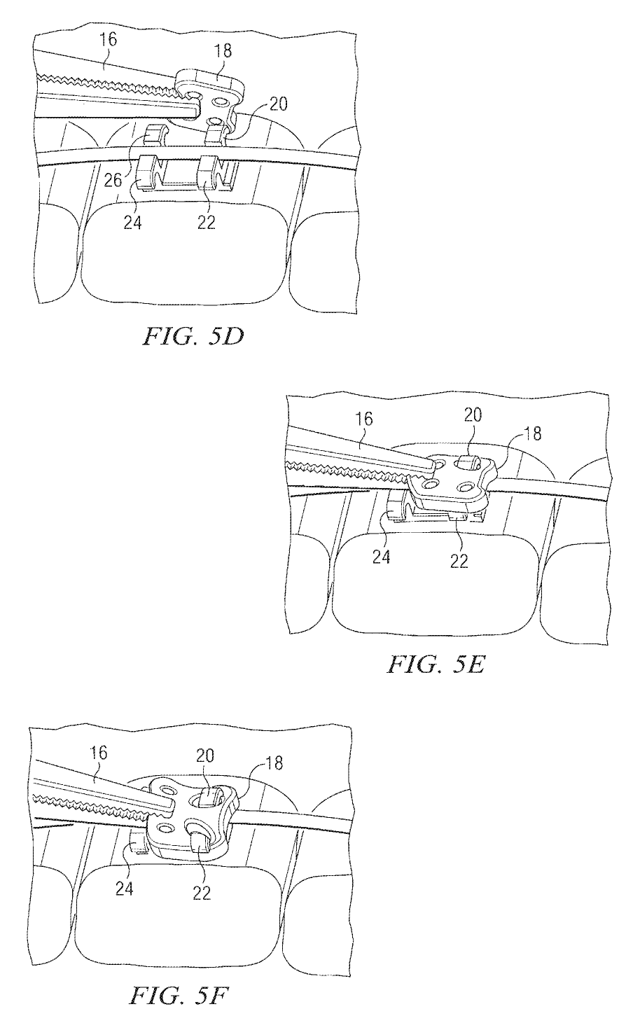

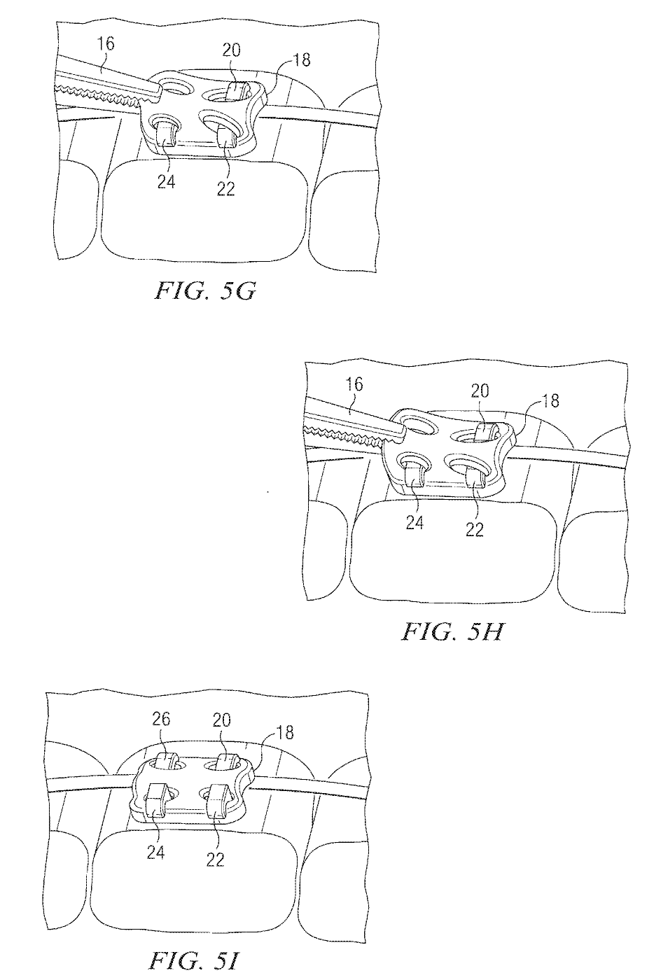

Referring to FIG. 5A the ligature of the present invention is conveniently packaged in the form of a ligature stick 14. In one embodiment the ligature stick 14 is 2.475 inches long, the parallel strips of ligatures being separated by a 0.16 inch retaining strip 15, with a total of twenty-four (24) ligatures on a ligature stick 14. The only instrument required to apply the ligatures is a conventional fine tipped forceps 16 or similar such instrument.

Referring now to FIGS. 5B through 5I application of a ligature of the present invention is shown. As shown in FIG. 5B using forceps 16 a ligature 18 is gripped centrally between the apertures 12. The ligature 18 is then lightly twisted and pulled until it separates from the ligature stick 14, as shown in FIG. 5C. Starting at the distal end of a bracket as shown in FIG. 5D and moving in a clockwise direction, the ligature 18 is applied. As shown in FIG. 5D the ligature 18 is first positioned over the distal gingival tie wing 20, then over the distal insisal tie wing 24, followed by the mesial incisal tie wing 24, and finally the mesial gingival tie wing 26. Once the ligature 18 is positioned over all of the tie wings 20-26, the ligature 18 is released, the application being complete. The forgoing application steps are illustrative only as a ligature of the present invention can be applied to the respective tie wings of a bracket in any order.

Although preferred embodiments of the invention have been illustrated in the accompanying Drawings and described in the foregoing Detailed Description, it will be understood that the invention is not limited to the embodiments disclosed, but is capable of numerous rearrangements, modifications, and substitutions of parts and elements without departing from the spirit of the invention.

1. An orthodontic ligature generally rectangular in shape, having four apertures disposed therein, the apertures oriented so as to be positioned over the tie wings of an orthodontic bracket, with the remainder of the ligature being of solid, elastic construction.

2. An orthodontic ligature having four apertures disposed therein wherein the ligature is 0.145 inches long, 0.125 inches wide at the ends, 0.095 inches wide at the sides, and 0.028 inches thick, with an inside aperture diameter of 0.02 inches, a distance between apertures of 0.04 inches at the occlusal-gingival side and 0.06 inches at the mesial-distal side, the distances between apertures measured from the centers of the apertures.
